(19) United States
(12) Patent Application Publication
(10) Pub. No.: US 2020/0020245 A1
(43) Pub. Date: Jan. 16, 2020

(54) INFORMATION PROCESSING APPARATUS, INFORMATION PROCESSING METHOD, AND PROGRAM

(71) Applicant: TOYOTA JIDOSHA KABUSHIKI KAISHA, Toyota-shi (JP)

(72) Inventors: Fumiki OHTANI, Toyota-shi (JP); Hirofumi KAMIMARU, Fukuoka-shi (JP); Riho MATSUO, Nagoya-shi (JP); Shodai KATO, Toyota-shi (JP); Atsushi YOSHIDA, Tokyo-to (JP); Shunsuke TANIMORI, Susono-shi (JP)

(73) Assignee: TOYOTA JIDOSHA KABUSHIKI KAISHA, Toyota-shi (JP)

(21) Appl. No.: 16/504,470

(22) Filed: Jul. 8, 2019

(30) Foreign Application Priority Data
Jul. 12, 2018 (JP) 2018-132405

(51) Int. Cl. G09B 9/052; B60W 40/09; G05D 1/02; G01C 21/34

(52) U.S. Cl. CPC G09B 9/052; G01C 21/3438; G05D 1/0212; B60W 40/09

(57) ABSTRACT

An objective is to encourage users who give teaching to carpool in a case where learning is provided between multiple users in a carpool vehicle. An information processing apparatus includes a controller and when learning is provided in a carpool vehicle between a teacher user who is a user giving teaching and a student user who is a user receiving the teaching, the controller acquires information for distinguishing between the teacher user and the student user, and gives an incentive to the teacher user.

### CROSS REFERENCE TO RELATED APPLICATION

This application claims priority to Japanese Patent Application No. 2018-132405, filed on Jul. 12, 2018, which is hereby incorporated by reference herein in its entirety.

### BACKGROUND

### Technical Field

The present disclosure relates to an information processing apparatus, an information processing method, and a program.

### Description of the Related Art

A way of traveling is known in which multiple users ride in the same vehicle together (for example, Patent document 1).

### CITATION LIST

### Patent Document

[Patent document 1] U.S. Patent Application Publication No. 2017/0351990

### SUMMARY

An objective of the present disclosure is to encourage users who give teaching to carpool in a case where learning is provided between multiple users in a carpool vehicle.

One aspect of the present disclosure is an information processing apparatus including a controller. When learning is provided in a carpool vehicle between a teacher user who is a user giving teaching and a student user who is a user receiving the teaching, the controller acquires information for distinguishing between the teacher user and the student user, and the controller gives an incentive to the teacher user.

One aspect of the present disclosure is an information processing method including: when learning is provided in a carpool vehicle between a teacher user who is a user giving teaching and a student user who is a user receiving the teaching, acquiring information for distinguishing between the teacher user and the student user; and giving an incentive to the teacher user.

One aspect of the present disclosure is a program that causes a computer to: when learning is provided in a carpool vehicle between a teacher user who is a user giving teaching and a student user who is a user receiving the teaching, acquire information for distinguishing between the teacher user and the student user, and give an incentive to the teacher user.

The present disclosure can encourage users who give teaching to carpool when learning is provided between multiple users in a carpool vehicle.

### BRIEF DESCRIPTION OF THE DRAWINGS

FIG. 1 is a diagram illustrating a schematic configuration of a carpool support system according to an embodiment;

FIG. 2 is a block diagram schematically illustrating one example of configurations of an apparatus of a vehicle, a user terminal, and a server constituting the carpool support system according to the first embodiment;

FIG. 3 is a diagram illustrating an example of the functional configuration of the server;

FIG. 4 is a diagram illustrating an example of a table configuration of travel information about a driving user;

FIG. 5 is a diagram illustrating an example of the table configuration of travel information about a passenger user;

FIG. 6 is a diagram illustrating an example of the table configuration of status information;

FIG. 7 is a diagram illustrating an example of the table configuration of incentive information stored in an incentive information DB according to the first embodiment;

FIG. 8 is a diagram illustrating an example of the table configuration of incentive information stored in an incentive information DB according to the first embodiment;

FIG. 9 is a diagram illustrating an example of a functional configuration of the user terminal;

FIG. 10 is a diagram illustrating one example of a screen for inputting user information, travel information, and status information shown on an output unit of the user terminal;

FIG. 11 is a diagram illustrating an example of a functional configuration of the apparatus of the vehicle;

FIG. 12 is a flow chart of matching processing according to the first embodiment;

FIG. 13 is a flow chart illustrating a flow for a travel path generating processing according to the first embodiment;

FIG. 14 is a flow chart illustrating a flow of incentive giving processing according to the first embodiment;

FIG. 15 is a diagram illustrating a sequence of processing in the carpool support system;

FIG. 16 is a flow chart illustrating a flow of incentive giving processing according to the second embodiment;

FIG. 17 is a diagram illustrating an example of the table configuration of incentive information stored in the incentive information DB;

FIG. 18 is a diagram illustrating functional elements of a user terminal in a case where a student user evaluates a teacher user;

FIG. 19 is a flow chart illustrating a flow of the incentive giving processing;

FIG. 20 is a diagram illustrating a sequence of processing in the carpool support system;

FIG. 21 is a diagram illustrating functional elements of the user terminal in a case where the student user gives an incentive to the teacher user indirectly via a server;

FIG. 22 is a flow chart illustrating a flow of the incentive giving processing;

FIG. 23 is a diagram illustrating a sequence of processing in the carpool support system; and

FIG. 24 is a diagram illustrating a sequence of processing in the carpool support system.

### DESCRIPTION OF THE EMBODIMENTS

The information processing apparatus which is one aspect of the present disclosure matches multiple carpool users among multiple demanding users demanding a carpool. Here, matching is to set a combination of users to ride on the same vehicle. Note that a combination of a vehicle and a user may be set through matching. Matching is performed so that learning between carpooling users is provided in such a manner that a user supposed to teach about a subject of learning (a teacher user) and a user supposed to be taught about the subject of learning (a student user) carpool in the same vehicle. Note that a user to be not involved by the learning may ride on the vehicle. Providing learning in a vehicle in this manner encourages carpooling in the vehicle. In addition, the teacher user carpooling in the vehicle is given an incentive. Examples of the incentive include money and goods, discount vouchers, gift certificates, predetermined type of points, preferential treatment for parking position applied when the teacher user uses a parking lot, preferential treatment for waiting for parking applied when the teacher user uses the parking lot, and room upgrade at an accommodation facility where the teacher user stays. Giving an incentive to the teacher user produces an advantage for the teacher user, facilitating collection of teacher users who desire carpooling. Accordingly, teacher users are encouraged to carpool and matching between teacher users and student users is facilitated, increasing the learning efficiency for student users.

Note that the controller may acquire information for distinguishing between the driver of the vehicle and non-driver of the vehicle, and give the incentive to the teacher user only when the teacher user is the driver of the vehicle. Giving the incentive in this manner secures a vehicle available for carpooling with the teacher user, encouraging the teacher user and the student user to carpool.

In addition, the controller may acquire the incentive, which is to be given to the teacher user, from the student user. In other words, the student user may give the teacher user the incentive directly or indirectly.

In addition, the controller may give the teacher user the incentive associated with the destination of the teacher user. For example, when the destination of the teacher user is a commercial facility such as a shopping mall, a discount ticket or gift certificate available in the commercial facility may be given as the incentive. When the destination of the teacher user is an accommodation such as a hotel, a discount ticket or gift certificate available in the accommodation may be given as the incentive, or the incentive may be room upgrade. When the teacher user is the driver of the vehicle used for carpooling and parks the vehicle at or around the destination, the incentive may be preferential treatment for the parking position or preferential treatment for waiting for parking. Preferential treatment for the parking position refers to, for example, allowing to preferentially park near a gate of the facility. Preferential treatment for waiting for parking refers to, for example, allowing to preferentially park without waiting even in a crowded parking lot. Giving such an incentive to a teacher user brings about the advantage of carpooling to move to the destination of the teacher user, thereby encouraging the teacher user to carpool.

In addition, the controller may acquire information on an evaluation of the teacher user from the student user, and give the teacher user the incentive according to the evaluation. Giving the incentive according to the evaluation of the teacher user made by the student user increases the quality of the content of a class given by the teacher user, thereby improving the learning efficiency for the student user. The controller can also change the incentive in stages according to the evaluation. In a case where the content of the class given by the teacher user does not satisfy the student user, no incentive may be given to the teacher user. This further increases the quality of the class given by the teacher user, thereby further improving the learning efficiency for the student user.

Embodiments of the present disclosure will now be described with reference to the accompanying drawings. The configurations in the embodiments below are merely illustrative, and the present disclosure is not limited to the configurations in the embodiments. Further, the embodiments below can be used in any combination possible.

### First Embodiment

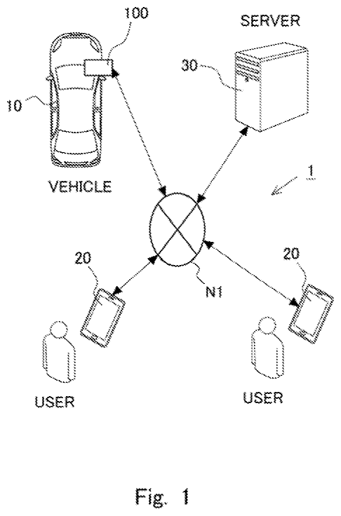

FIG. 1 is a diagram illustrating a schematic configuration of a carpool support system 1 according to this embodiment. In the example illustrated in FIG. 1, the carpool support system 1 includes an apparatus 100 installed in the vehicle 10, user terminals 20, and a server 30. The apparatus 100, the user terminals 20, and the server 30 are connected to each other via a network N1. Note that the network N1 is, for example, a worldwide public communication network, such as the Internet, and may be a wide area network (WAN) or other communication networks. In addition, the network N1 may include a telephone communication network such as that for cellular phones, or a wireless communication network such as WiFi.

The carpool support system 1 performs matching so that multiple users ride on one vehicle 10, and generates a travel path along which matched users can ride. In a case where users demand a certain type of learning, matching is performed so that a user who teaches about the subject of learning (a user acting as a teacher (hereinafter referred to as a teacher user)) and a user who is taught (a user acting as a student (hereinafter referred to as a student user)) can ride on the same vehicle 10. The following description is based on the assumption that the teacher user gives the student user an English lesson in the vehicle 10. Note that the driver of the vehicle 10 will hereinafter be referred to as a “driver user”, and carpool partners other than the driver user (non-drivers) are referred to as “passenger users”. When not distinguished from each other, the teacher user, student users, driver user, and passenger users are simply referred to as a “user”. A user terminal 20 is a terminal used by a demanding user. Although two user terminals 20 are illustrated in FIG. 1, demanding users each possess a user terminal 20 and as many user terminals 20 as demanding users exist. Further, although a single vehicle 10 is illustrated in FIG. 1, multiple vehicles 10 exist and each vehicle 10 includes an apparatus 100. The apparatus 100 can also be used by a driver user. Besides, this embodiment is applicable to vehicles that perform automatic driving (hereinafter referred to as automatic driving vehicles), and in this case, no driver users exist.

The server 30 acquires information indicating that a user who demands carpooling (a demanding user) is a teacher user or student user, prior to matching between carpool users. In the description below, information indicating a teacher user or student user is also called information about a learning attribute. Further, the server 30 acquires information indicating that a demanding user is a driver user or passenger user, prior to matching between carpool users. In the description below, information indicating a driver user or passenger user is also called information about a driving attribute. The information about a learning attribute and the information about a driving attribute are transmitted from the user terminal 20 to the server 30, and stored in the server 30.

Subsequently, the server 30 matches multiple users to ride the vehicle 10 from among the demanding users according to acquired information about the driving attribute, so that a driver user and a passenger user can carpool in the same vehicle. Further, the server 30 matches multiple users to ride the vehicle 10 according to acquired information about the learning attribute, so that a teacher user and a student user can carpool in the same vehicle. Upon completion of matching of users, the server 30 generates a travel path of the vehicle 10 according to the current position and the destination of each user. This travel path is transmitted to the user terminals 20 or the apparatus 100 of the vehicle 10. Note that the user terminals 20 or the apparatus 100 of the vehicle 10 may just present the received travel path or guide the travel direction of the vehicle 10 along the received travel path. In a case of an automatic driving vehicle, the apparatus 100 moves the vehicle 10 along the travel path.

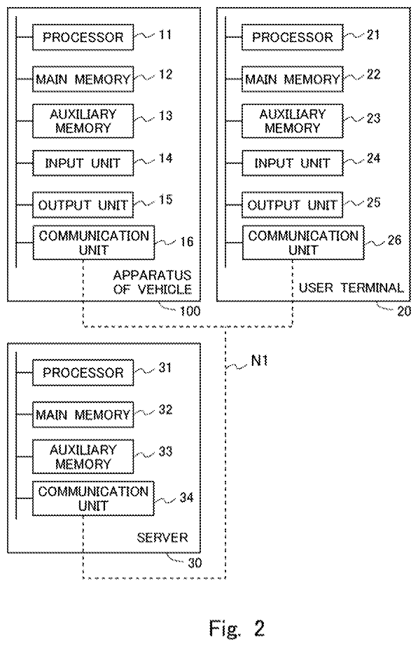

Hardware configurations of the apparatus 100, the user terminals 20, and the server 30 will now be described with reference to FIG. 2. FIG. 2 is a block diagram schematically illustrating one example of the configurations of the apparatus 100, the user terminals 20, and the server 30 constituting the carpool support system 1 according to this embodiment.

The server 30 has a typical computer configuration. The server 30 includes a processor 31, a main memory 32, an auxiliary memory 33, and a communication unit 34. They are connected to each other via a bus.

The processor 31 is a central processing unit (CPU), a digital signal processor (DSP), or the like. The processor 31 controls the server 30 and performs various logic operations for information processing. The processor 31 is an example of a “controller”. The main memory 32 is a random access memory (RAM), read only memory (ROM), or the like. The auxiliary memory 33 is an erasable programmable ROM (EPROM), a hard disk drive (HDD), a removal medium, or the like. The auxiliary memory 33 stores an operating system (OS), various programs, various tables, and the like. The processor 31 loads the programs stored in the auxiliary memory 33 onto the work area of the main memory 32 and executes it, and the components are controlled through this execution of the programs. Thus, the server 30 implements a function meeting a predetermined objective. The main memory 32 and the auxiliary memory 33 are computer-readable recording media. Note that the server 30 may be a single computer or multiple computers in cooperation. Information stored in the auxiliary memory 33 may be stored in the main memory 32. Information stored in the main memory 32 may be stored in the auxiliary memory 33.

The communication unit 34 is a unit configured to communicate with the user terminals 20 and the apparatus 100 of the vehicle 10 via the network N1. The communication unit 34 is, for example, a wireless communication circuit for a local area network (LAN) interface board or wireless communication. The LAN interface board or the wireless communication circuit is connected to the network N1.

Note that a sequence of processing executed in the server 30 can be executed with hardware or software.

The user terminals 20 will now be described. Each user terminal 20 is, for example, a smartphone, a cellular phone, a tablet terminal, a personal information terminal, a wearable computer (such as a smartwatch), a personal computer (PC), or other compact computers. Each user terminal 20 includes a processor 21, a main memory 22, an auxiliary memory 23, an input unit 24, an output unit 25, and a communication unit 26. They are connected to each other via a bus. Description of the processor 21, the main memory 22, and the auxiliary memory 23, which are similar to the processor 31, the main memory 32, and the auxiliary memory 33 in the server 30, will be omitted.

The input unit 24 is a unit configured to receive an input operation from a user, for example, a touch screen, a push-button, or the like. The output unit 25 is a unit configured to show information to the user, for example, a liquid crystal display (LCD), an electroluminescence (EL) panel, a speaker, a lamp, or the like. The input unit 24 and the output unit 25 may constitute one touch screen display. The communication unit 26 is a communication unit configured to connect the user terminals 20 to the network N1. The communication unit 26 is, for example, a circuit for communication with other devices (for example, the server 30) via the network N1 by utilizing a mobile communication service (a telecommunication network, such as 3rd Generation (3G) or long term evolution (LTE), or a wireless communication, such as WiFi).

The apparatus 100 of the vehicle 10 will now be described. The apparatus 100 includes a processor 11, a main memory 12, an auxiliary memory 13, an input unit 14, an output unit 15, and a communication unit 16. They are connected to each other via a bus. They are similar to the processor 21, the main memory 22, the auxiliary memory 23, the input unit 24, the output unit 25, and the communication unit 26 of the user terminal 20, and their description will therefore be omitted. Note that the apparatus 100 of the vehicle 10 is, for example, a smartphone, a cellular phone, a tablet terminal, a personal information terminal, a wearable computer (such as a smartwatch), a personal computer (PC), or other compact computers removable from the vehicle 10.

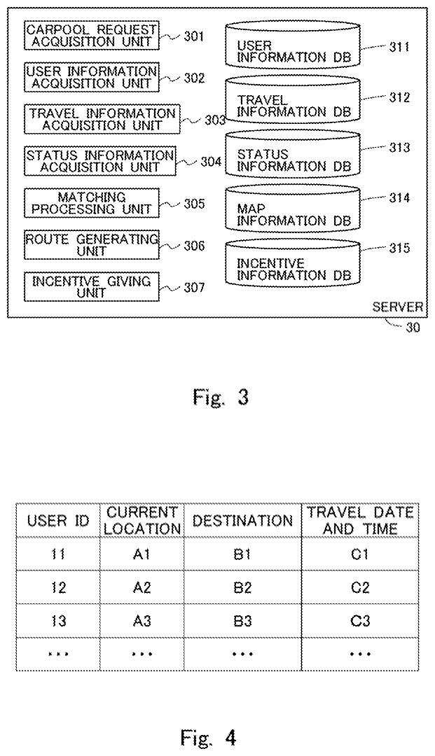

A function of the server 30 will now be explained. FIG. 3 is a diagram illustrating an example of a functional configuration of the server 30. The server 30 includes, as functional components, a carpool request acquisition unit 301, a user information acquisition unit 302, a travel information acquisition unit 303, a status information acquisition unit 304, a matching processing unit 305, a route generating unit 306, an incentive giving unit 307, a user information DB 311, a travel information DB 312, a status information DB 313, a map information DB 314, and an incentive information DB 315. The processor 31 in the server 30 executes processing in the carpool request acquisition unit 301, the user information acquisition unit 302, the travel information acquisition unit 303, the status information acquisition unit 304, the matching processing unit 305, the route generating unit 306 and the incentive giving unit 307, using computer programs in the main memory 32. Note that any one of the functional components or part of their processing may be executed with a hardware circuit.

The user information DB 311, the travel information DB 312, the status information DB 313, the map information DB 314 and the incentive information DB 315 are constructed when programs in a database management system (DBMS) executed by the processor 31 manage data stored in the auxiliary memory 33. The user information DB 311, the travel information DB 312, the status information DB 313, the map information DB 314 and the incentive information DB 315 are, for example, a relational database.

Note that any one of the functional components of the server 30 or part of their processing may be executed with a different computer connected to the network N1.

The carpool request acquisition unit 301, for example, acquires a carpool request from the user terminal 20 of a user who demands a carpool (a demanding user). A carpool request is information that includes a user's identifier and is used to request matching between the user and other users. The user information acquisition unit 302 acquires, for example, information (user information) on the user corresponding to the user terminal 20 that is the source of the carpool request, from a user information DB 311 which will be described later.

The user information DB 311 is made up with user information stored in the auxiliary memory 33 and is where association between the user and user information is performed. The user information includes, for example, a user ID associated with the user. The user ID is an identifier unique to each user. User information corresponding to the user ID (for example, a name and address, and in a case where the user is a driving user, a car type, vehicle color, vehicle number, vehicle capacity, and the like) may be pre-registered by the user through the user terminal 20 or may be transmitted from the user terminal 20 together with the carpool request.

The travel information acquisition unit 303 acquires travel information about a user who demands a carpool. The travel information is information that is transmitted from the user terminal 20 to the server 30 together with the carpool request, and is related to a user's current location, destination, and travel date and time. Upon acquisition of travel information, the travel information acquisition unit 303 stores the travel information in the travel information DB 312 which will be described later.

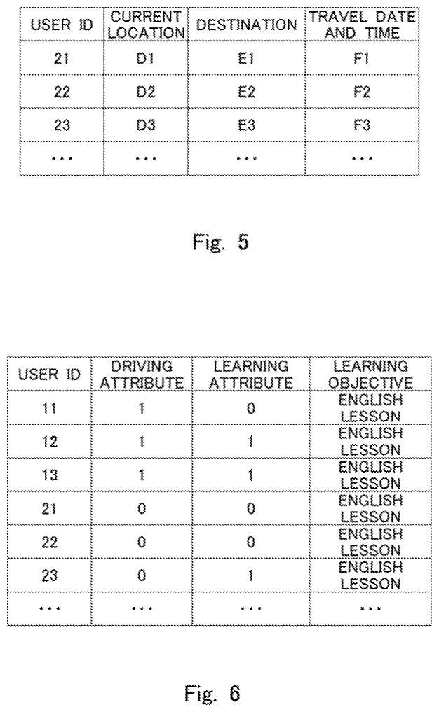

The travel information DB 312 is made up with travel information stored in the auxiliary memory 33 and is where association between the user and travel information is performed. A structure of travel information stored in the travel information DB 312 will now be described with reference to FIGS. 4 and 5. FIG. 4 is a diagram illustrating an example of a table configuration of travel information about a driving user. FIG. 5 is a diagram illustrating an example of the table configuration of travel information about a passenger user. Note that information indicating whether the user who demands a carpool is a driving user or a passenger user may be prestored in the user information DB 311 in the state where it is associated with the user ID or may be included in the travel information or status information which will be described later. In a case of an automatic driving vehicle, all users are treated as passenger users. A driving user travel information table and a passenger user travel information table each include the fields of user ID, current location, destination, and travel date and time. In the user ID field, identification information for identifying users is input. In the current location field, information indicating the current locations of users is input. Note that, a current location of a passenger user may be a location where he/she demands to get the vehicle 10. In the driving user's current location field, information indicating the current location of the vehicle 10 may be input. In the destination field, information indicating the destinations of users is input. The destination of a passenger user may be a point where he/she demands to get off the vehicle 10. The destination of the driver user may be a point where he/she is going to park the vehicle 10. The current location and the destination are, for example, represented by a latitude and a longitude. In the travel date and time field, information indicating a desired date and time of a carpool is input. Regarding a case, for example, where multiple users having the same destination and travel date and time join a carpool such as where employees of the same company join a carpool to commute in the morning, input of the destination and travel date and time may be omitted.

Next, the status information acquisition unit 304 acquires status information about a user who demands a carpool. Status information is information transmitted from the user terminal 20 to the server 30 together with the carpool request, and is information about the driving attribute, information about the learning attribute, and information about the learning objective of the user. Upon acquisition of the status information, the status information acquisition unit 304 stores the status information in the status information DB 313 which will be described later.

The status information DB 313 is made up with the status information stored in the auxiliary memory 33 and is where association between the user and the status information is performed. The structure of the status information stored in the status information DB 313 will now be described with reference to FIG. 6. FIG. 6 is a diagram illustrating an example of the table configuration of the status information. A status information table includes fields of user ID, driving attribute, learning attribute, and learning objective. In the user ID field, identification information for identifying users is input. In the driving attribute field, information about a driving attribute of demanding users are input. In the example illustrated in FIG. 6, “1” is input for a driver user, and “0” is input for a passenger user. In the learning attribute field, information about a learning attribute of demanding users are input. In the example illustrated in FIG. 6, “1” is input when the user is a teacher user, and “0” is input when the user is a student user. In the learning objective field, information indicating an objective of learning the user demanding a carpool desires is input. A learning objective is, in a case of a student user, information corresponding to the content of learning that the student user demands to receive, and, in a case of a teacher user, information corresponding to the content of learning that the teacher user demands to teach. Although an English lesson is given as an example of a learning objective in FIG. 6, a learning objective may be any objective aimed at mastering knowledge or skills and not limited to an English lesson. Users having no learning objective may exist. For users having no learning objective, information indicating the absence of a learning objective may be input or nothing may be input in the learning attribute field.

The matching processing unit 305 will now be described. The matching processing unit 305 performs matching so that a driver user and a passenger user carpool in the vehicle 10, and a teacher user and a student user having the same learning objective carpool in the vehicle 10. Any known technique may be used as the matching method. The matching processing unit 305 searches for passenger users whose current location and destination are within an area a predetermined distance from a scheduled route of the travel of the driving user on the driving user's travel date and time. Note that, in a case of an automatic driving vehicle, passenger users whose current location and destination are within an area a predetermined distance from a scheduled route of the travel of the vehicle 10 are searched. The scheduled route of the travel is generated based on current location and destination of the driving user (which may be the vehicle 10) and the map information stored in the map information DB 314. Note that the predetermined distance is a distance suitable for a carpool, and the area a predetermined distance away is, for example, an area in the same district. Further, the matching processing unit 305 compares each user's status information, and matches users having the same learning objective. Further, the matching processing unit 305 performs comparison between status information about the users and matches users so that a teacher user and a student user are included in carpool users of the same vehicle 10.

Note that the map information DB 314 stores, as the map information, for example, link data on roads (links), node data on node points, intersection data on intersections, search data for searching for routes, facility data on facilities, search data for searching for locations, and the like.

The route generating unit 306 generates a travel path of the vehicle 10 passing the current locations and destinations of the users matched through the matching processing unit 305. The travel path is generated based on each user's current location and destination and the map information stored in the map information DB 314. The travel path is generated so that it can be a path according to predetermined rules, such as a path along which the shortest travel distance of the vehicle 10 is achieved or a path along which the shortest travel time of the vehicle 10 is achieved. The route generating unit 306 transmits the generated travel path to the apparatus 100 of the vehicle 10 or the user terminals 20.

The incentive giving unit 307 gives a teacher user an incentive. The incentive giving unit 307 generates data (hereinafter also referred to as incentive data) to be transmitted to the user terminal 20 of the teacher user according to information (hereinafter also referred to as incentive information) on the incentive, and transmits this incentive data to the user terminal 20 of the teacher user. Incentive information is stored in the incentive information DB 315. The incentive information DB 315 is made up with incentive information stored in the auxiliary memory 33. Note that the same incentive may be given to all the teacher users or the incentive may be different depending on each teacher user.

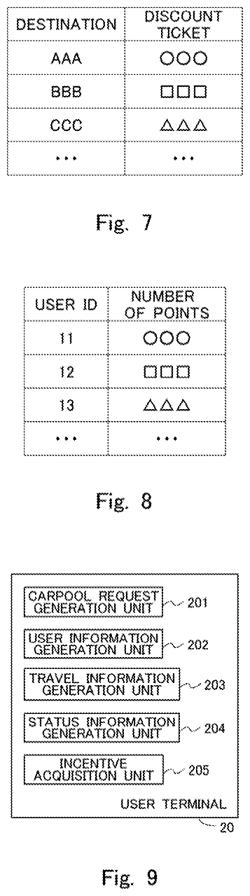

An incentive is given, for example, by transmitting a discount ticket or gift certificate to the user terminal 20 of a teacher user. For example, electronic data of a discount ticket or gift certificate available at a facility or the like that the teacher user is going to use after getting off may be transmitted to the user terminal 20 of the teacher user as incentive data. Alternatively, an incentive related to the destination of the teacher user may be given to the teacher user. For example, electronic data of a discount ticket or gift certificate available at a facility or the like around the destination of the teacher user may be given. Alternatively, electronic data of a discount ticket or gift certificate available at a facility or the like registered to the server 30 in advance by the teacher user through the user terminal 20 may be given. Here, an example in which a discount ticket available at a facility around the destination of the teacher user is given as an incentive will be described with reference to FIG. 7. FIG. 7 is a diagram illustrating an example of a table configuration of incentive information stored in the incentive information DB 315. An incentive information table includes a destination field and a discount ticket field. In the destination field, information on destinations is input. In the discount ticket field, information on discount tickets related to destinations is input. The incentive giving unit 307 selects information on a discount ticket related to the destination of the teacher user, according to incentive information stored in the incentive information DB 315 and the destination of the teacher user stored in the travel information DB 312. The incentive giving unit 307 then generates incentive data corresponding to the discount ticket and transmits it to the user terminal 20.

An incentive may be given, for example, by transmitting a predetermined type of points to the user terminal 20 of the teacher user. The predetermined type of points are exchangeable with, for example, money or goods corresponding to the number of points. This predetermined type of points may be available at the destination of the teacher user. Here, an example in which a predetermined type of points are given as an incentive will be described with reference to FIG. 8. FIG. 8 is a diagram illustrating an example of the table configuration of incentive information stored in the incentive information DB 315. The incentive information table includes the fields of user ID and the number of points. In the user ID field, identification information for identifying users is input. In the number of points field, information on the number of points to be given to teacher users is input. The number of points to be given to teacher users may be the same among all the teacher users, or may be determined according to the skills or evaluation of each teacher user. The incentive giving unit 307 refers to the number of points field stored in the incentive information DB 315, and generates incentive data corresponding to the number of points according to each teacher user. Moreover, the incentive giving unit 307 transmits the incentive data to the user terminal 20 of each teacher user. Note that the incentive giving unit 307 may give teacher users electronic money instead of points.

The timing at which the incentive giving unit 307 gives an incentive to the teacher user is, for example, when the teacher user gets on or off, or when the student user gets on or off. When multiple student users get on, an incentive may be given to the teacher user every time a student user gets on or off, or when all the student users get on or off. Further, when the teacher user requests the incentive giving unit 307 to give an incentive via the user terminal 20 after the teacher user gets off, the incentive may be given to the teacher user.

A function of the user terminal 20 will now be explained. FIG. 9 is a diagram illustrating an example of a functional configuration of the user terminal 20. Each user terminal 20 includes, as functional components, a carpool request generation unit 201, a user information generation unit 202, a travel information generation unit 203, a status information generation unit 204, and an incentive acquisition unit 205. The processor 21 in the user terminal 20 executes processing in the carpool request generation unit 201, the user information generation unit 202, the travel information generation unit 203, the status information generation unit 204, and the incentive acquisition unit 205, using computer programs in the main memory 22. Note that any one of the functional components or part of their processing may be executed with a hardware circuit.

The carpool request generation unit 201 shows an operating screen on the output unit 25 and generates a user carpool request according to a user's input to the input unit 24. For example, the carpool request generation unit 201 outputs an icon or the like used to issue a carpool request to a touch screen display, and a carpool request is generated when the user clicks the icon. The carpool request generation unit 201 associates the generated carpool request with a user ID and transmits it to the server 30. The carpool request is generated on the user terminal 20 of the driver user and the user terminal 20 of the passenger user.

The user information generation unit 202 generates user information. The user information generation unit 202 shows an operating screen for promoting an input of user information on the output unit 25 and generates the user information according to a user's input to the input unit 14. The generated user information is transmitted by the carpool request generation unit 201 to the server 30 together with a carpool request. Note that the user information may be input by the user through the input unit 24 in advance and stored in the auxiliary memory 23 of the user terminal 20. The user information generation unit 202 may generate the user information based on data stored in the auxiliary memory 23. In addition, the user information generation unit 202 may generate the user information before the carpool request is generated and transmit it to the server 30. For example, the user information may be generated upon user registration and transmitted to the server 30. In this case, the user information is stored in the user information DB 311 of the server 30 in advance.

The travel information generation unit 203 generates user's travel information. The travel information generation unit 203 shows an operating screen for promoting an input of the travel information on the output unit 25 and generates the travel information according to a user's input to the input unit 14. The generated travel information is transmitted by the carpool request generation unit 201 to the server 30 together with a carpool request. Note that the travel information may be input by the user through the input unit 24 in advance and stored in the auxiliary memory 23 of the user terminal 20. The travel information generation unit 203 may generate the travel information based on data stored in the auxiliary memory 23. In a case where the user terminals 20 have a global positioning system (GPS), the positions of the user terminals 20 may be detected through reception of radio waves transmitted from satellites upon generation of the travel information, and the travel information generation unit 203 may determine these positions of the user terminals 20 as user's current locations. In a case where the apparatus 100 of the vehicle 10 has a GPS, the apparatus 100 may detect the position of the vehicle 10 by receiving radio waves transmitted from satellites and determine this position of the vehicle 10 as a driving user's current location. In this case, the apparatus 100 has the same functions as the travel information generation unit 203. In this case, at predetermined time (for example, 60 seconds) intervals, information about the current location of the vehicle 10 detected through the GPS may be transmitted from the apparatus 100 to the server 30 together with the user ID. The server 30 updates the driving user's current location stored in the travel information DB 312, based on the information transmitted from the apparatus 100. Note that in a case of the automatic driving vehicle, the current location of the vehicle 10 detected through the GPS is transmitted from the apparatus 100 to the server 30 at predetermined time intervals.

The status information generation unit 204 generates user's status information. The status information generation unit 204 shows an operating screen for promoting an input of the status information on the output unit 25 and generates the status information according to a user's input to the input unit 14. The generated status information is transmitted by the carpool request generation unit 201 to the server 30 together with a carpool request. Note that the status information may be input by the user through the input unit 24 in advance and stored in the auxiliary memory 23 of the user terminal 20. The status information generation unit 204 may generate the status information based on data stored in the auxiliary memory 23. In addition, the status information generation unit 204 may generate the status information before the carpool request is generated and transmit it to the server 30.

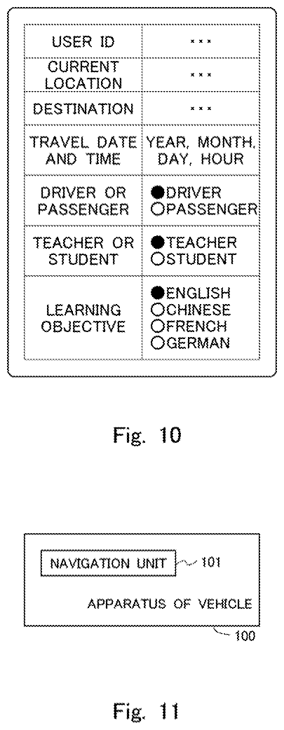

FIG. 10 is a diagram illustrating one example of a screen for inputting the user information, travel information, and status information shown on the output unit 25 of the user terminal 20. For the user ID, current location, destination, travel date and time, and test score fields, the users input text. In addition, in the driving attribute, learning attribute, and, learning objective fields, selection is made when the user pushes the button of a prepared icon. Information input to the user terminal 20 is transmitted to the server 30 together with the carpool request.

The incentive acquisition unit 205 acquires incentive data transmitted from the incentive giving unit 307. The incentive data acquired by the incentive acquisition unit 205 is stored in the auxiliary memory 23. Further, the incentive acquisition unit 205 forces the output unit 25 to give an output according to the acquired incentive data. Note that the user terminal 20 can force the output unit 25 to output an image according to the incentive data stored in the auxiliary memory 23 in response to a user's operation on the input unit 24. For example, when a predetermined type of points are given to the teacher user as an incentive, the number of points given and the total number of points are output to the output unit 25. Note that points are treated with a predetermined application installed in the user terminal 20. For example, when the incentive data is the electronic data of a discount ticket available at a facility, the incentive acquisition unit 205 forces the output unit 25 to display the discount ticket in response to the user's operation on the input unit 24. The user can receive a discount on the usage fee of the facility by presenting the discount ticket when using the facility. Note that the incentive acquisition unit 205 may have a function of requesting the server 30 to give an incentive.

A function of the apparatus 100 of the vehicle 10 will now be described. FIG. 11 is a diagram illustrating an example of a functional configuration of the apparatus 100. The apparatus 100 includes, as a functional component, a navigation unit 101. The processor 11 of the apparatus 100 executes processing in the navigation unit 101 through computer programs in the main memory 12. Note that any one of the functional components or part of their processing may be executed with a hardware circuit.

The navigation unit 101 shows a map of an area at or around the current location of the vehicle 10 on the output unit 15 based on the map information and the like stored in the auxiliary memory 13. In addition, upon reception of a travel path from the server 30, the navigation unit 101 guides the path according to the received travel path. At the time, the navigation unit 101 outputs the travel path to the output unit 15 of the apparatus 100. The navigation unit 101 shows, for example, a map and a travel path on the display or guides travel directions with a sound according to the travel path. The function of the navigation unit 101 can be implemented by using a well-known technique.

Although the travel paths are generated in the route generating unit 306 of the server 30 in the carpool support system 1, this generation of the travel paths may be performed in the navigation unit 101 of the apparatus 100. In this case, the server 30 transmits the travel information about each user matched to the apparatus 100, and the navigation unit 101 generates a travel path based on the travel information about each user and the map information stored in the auxiliary memory 13. The map information stored in the auxiliary memory 13 is information equivalent to the map information stored in the map information DB 314 of the server 30.

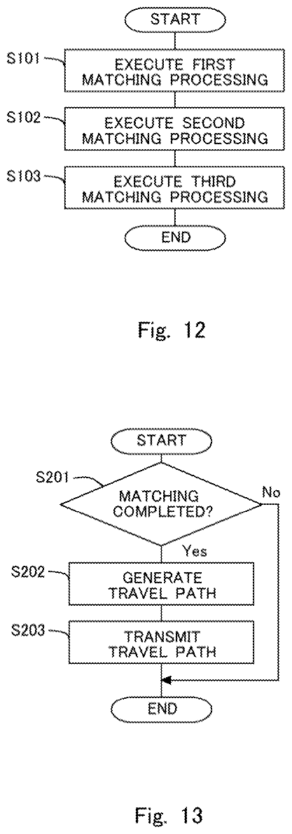

Matching processing executed by the matching processing unit 305 in the server 30 will now be described. FIG. 12 is a flow chart of the matching processing according to this embodiment. The matching processing illustrated in FIG. 12 is executed in the matching processing unit 305 at a predetermined time. The matching processing is processing for combining carpool users. In a case where learning is assumed to be performed during a commute, the predetermined time is, for example, a time at which the commute starts. Note that the matching processing may be executed at predetermined time intervals. The matching processing illustrated in FIG. 12 is executed for each driver user transmitting the carpool request from the user terminal 20, or each vehicle 10 registered as a vehicle 10 available for carpooling.

In step S101, a first matching processing is executed based on information stored in the travel information DB 312. In the first matching processing, a driver user transmitting the carpool request from the user terminal 20 and a passenger user transmitting the carpool request from the user terminal 20 are matched. In the first matching processing, passenger users whose current location and destination are within an area a predetermined distance from a scheduled route of the travel of the driving user on the driving user's travel date and time are searched and combined. In a case of the automatic driving vehicle, no driving user exists, so that in the first matching processing, passenger users whose current location and destination are within an area a predetermined distance from a scheduled route of the travel of the automatic driving vehicle on the travel date and time of the automatic driving vehicle are searched and combined. Automatic driving vehicles are pre-registered to the server 30 as vehicles 10 available for carpooling. In the first matching processing, more users than passengers that the vehicle 10 can contain may be matched. In the first matching processing, matching may be performed using a well-known matching technique based on the information stored in the travel information DB 312. Regarding a case, for example, where it is assumed that users having the same destination and travel date and time join a carpool such as where employees of the same company join a carpool to commute in the morning, the first matching processing may be omitted.

Subsequently, in step S102, a second matching processing is executed based on information stored in the status information DB 313. In the second matching processing, teacher users and student users who have the same learning objective are selected among the users matched in the first matching processing and combined. Note that, in the second matching processing, more users than passengers that the vehicle 10 can contain may be matched. For example, for a manual-drive vehicle 10, a driving user rides on it with no exception and passenger users having the same learning objective as the driving user may be matched. The matching processing unit 305 refers to the learning objective field in the status information stored in the status information DB 313 and matches, from among the users matched in the first matching processing, users for which the same learning objective is input. In a case where the driving user has no learning objective, passenger users having the same learning objective may be matched together. In a case where no passenger users who have the same learning objective as the driving user exist, or in a case of an automatic driving vehicle, passenger users who have the same learning objective may be matched together. When users having the same learning objective do not exist or when the number of users having the same learning objective is less than the seat capacity of the vehicle 10, users having different learning objectives may be matched or users having no learning objective may be matched, or users may be matched independently of their learning objectives. Thus, when a user having different learning objective rides on the vehicle 10 together, the opportunities of carpool can be increased.

In step S103, third matching processing is executed based on information stored in the status information DB 313. In the third matching processing, teacher users and student users are selected among the users matched in the second matching processing and combined. In particular, in the third matching processing, the matching processing unit 305 refers to the learning attribute field in the status information stored in the status information DB 313 and matches, from among the users matched in the second matching processing, one teacher user and one or more student users. Note that the teacher user may be selected according to the learning level of the student user(s). In the third matching processing, matching is performed so that the number of users who get on becomes always less than or equal to the seat capacity of the vehicle 10. Note that the order of processing in step S101, step S102, and step S103 may be changed. In this case, matching is performed in the final matching processing so that the number of users to join a carpool becomes less than or equal to the seat capacity of the vehicle 10. Carpool users can be matched by any other known method than the method illustrated in the flow chart illustrated in FIG. 12.

FIG. 13 is a flow chart illustrating a flow for generating the travel path (travel path generating processing). This flow chart is executed in the route generating unit 306 of the server 30 at predetermined time intervals. Note that the flow chart illustrated in FIG. 13 may follow the matching processing illustrated in FIG. 12. In step S201, whether or not user matching by the matching processing unit 305 has been completed is determined. When a positive determination is made in step S201, the process proceeds to step S202, and when a negative determination is made, the flow chart is terminated. In step S202, the travel path is generated so that users matched in the matching processing can join a carpool in the vehicle 10. In subsequent step S203, the travel path is transmitted from the server 30 to the user terminal 20 or the apparatus 100.

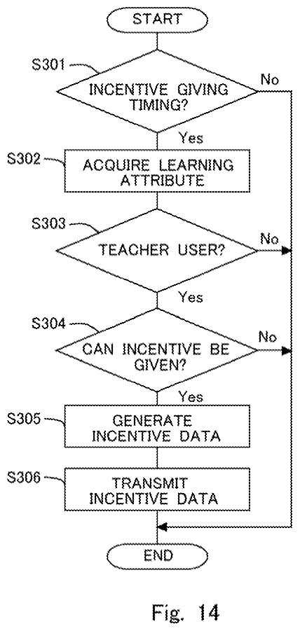

FIG. 14 is a flow chart illustrating a flow of processing for giving a teacher user an incentive (incentive giving processing). This flow chart is executed in the incentive giving unit 307 of the server 30 for each user at predetermined time intervals. In step S301, whether or not it is the timing of giving the teacher user an incentive is determined. The timing of giving the teacher user an incentive is predetermined. When a positive determination is made in step S301, the process proceeds to step S302, and when a negative determination is made, the flow chart is terminated. In step S302, a learning attribute is acquired. The incentive giving unit 307 acquires the learning attribute of the user from the status information DB 313. In subsequent step S303, whether or not the user is a teacher user is determined. When a positive determination is made in step S303, the process proceeds to step S304, and when a negative determination is made, the flow chart is terminated. In step S304, whether or not an incentive can be given to the teacher user is determined. For example, in a case of a failure in matching of student users having the same learning objective, the teacher user does not provide a class, so that it is determined that an incentive is not to be given. When a positive determination is made in step S304, the process proceeds to step S305, and when a negative determination is made, the flow chart is terminated. In step S305, incentive data is generated. This incentive data may be pre-stored in the auxiliary memory 33 of the server 30. In subsequent step S306, the incentive data is transmitted from the server 30 to the user terminal 20 of the teacher user, thereby giving an incentive to the teacher user.

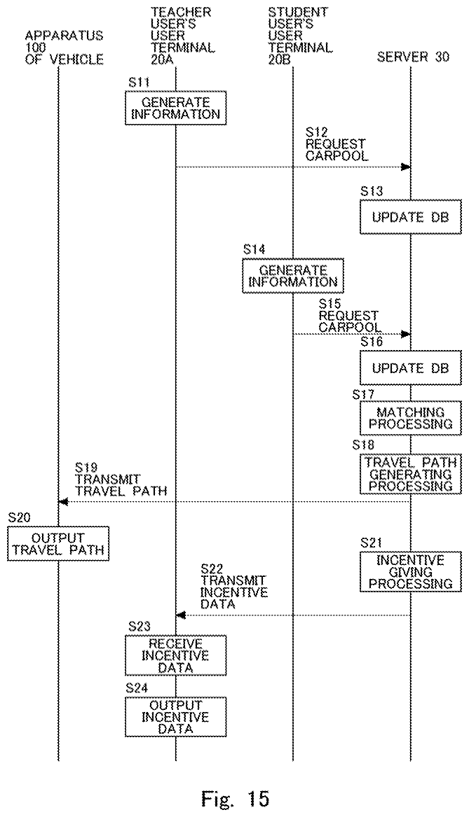

An operation of the carpool support system 1 will now be explained. FIG. 15 is a diagram illustrating a sequence of the processing of the carpool support system 1. In the sequence diagram illustrated in FIG. 15, it is assumed that one teacher user and one student user get on the vehicle 10, and the teacher user is a driver user, and the student user is a passenger user. In FIG. 15, the user terminal of the teacher user is denoted by the reference numeral 20A, and the user terminal of the student user is denoted by the reference numeral 20B. When the teacher user operates the input units 24 of the user terminal 20A to input the user information, the travel information, and the status information, each user terminal 20A generates the carpool request, the user information, the travel information, and the status information (processing in S11). Subsequently, each user terminal 20A transmits the carpool request, the user information, the travel information, and the status information to the server 30 (processing in S12). Upon reception of the carpool request, the user information, the travel information, and the status information from the user terminal 20A, the server 30 updates the travel information DB 312 and the status information DB 313 (processing in S13). When the student user operates the input unit 24 of the user terminal 20B to input user information, travel information, and status information, the user terminal 20B generates a carpool request, user information, travel information, and status information (processing in S14). Subsequently, the user terminal 20B transmits the carpool request, user information, travel information, and status information to the server 30 (processing in S15). Upon reception of the carpool request, user information, travel information from the user terminal 20B, and status information, the server 30 updates the travel information DB 312 and the status information DB 313 (processing in S16).

In addition, at a predetermined time, the server 30 executes the matching processing (processing in S17). In S17, the server 30 executes the matching processing illustrated in FIG. 12. The server 30 searches for users who can join a carpool based on the travel information and status information associated with the user IDs and combines them. Upon completion of matching, the server 30 generates a travel path based on the travel information of each user (processing in S18). In S18, the server 30 executes the travel path generating processing illustrated in FIG. 13. The travel path is generated so that it extends from the current position of the driver user (that is, the teacher user) to the current position of the student user, the destination of the student user, and then the destination of the driver user. Information about the generated travel path is transmitted from the server 30 to the apparatus 100 (processing in S19). The apparatus 100 receiving the information about the travel path outputs the travel path to the output unit 15 and guides the driving user (that is, the teacher user) along the travel path (processing in S20). Note that the server 30 may transmit the travel path to the apparatus 100 and, at the same time, the travel path and the notification of the completion of the matching to the user terminal 20A of the teacher user and the user terminal 20B of the student user. Upon reception of the travel path and the notification of the completion of the matching, in the user terminal 20A of the teacher user and the user terminal 20B of the student user, the processor 21 outputs the travel path and the notification of the completion of the matching to the output unit 25.

After the transmission of the travel path, the server 30 executes incentive giving processing (processing in S21). In S21, the server 30 executes the incentive giving processing illustrated in FIG. 14. When incentive data is generated in this incentive processing, the incentive data is transmitted to the user terminal 20A of the teacher user (processing in S22), and the user terminal 20A receives this incentive data (processing in S23). Upon reception of the incentive data, the user terminal 20A of the teacher user gives an output according to the incentive data to the output unit 25 (processing in S24).

As described above, according to this embodiment, when multiple users to carpool in the vehicle 10 join a learning in the vehicle 10, an incentive is given to the teacher user; therefore, teacher users can be encouraged to carpool. Hence, learning efficiency for student users can be increased and student users whose objective is learning can be encouraged to carpool.

### Second Embodiment

In a second embodiment, an incentive is given to a teacher user only when the teacher user is a driver user. In particular, when the teacher user is a passenger user, no incentive is given to the teacher user. Here, to encourage carpooling, more vehicles 10 available for carpooling are preferably secured. Since an incentive is given to a teacher user only when the teacher user is a driver user, more driver users who can be teacher users can be collected.

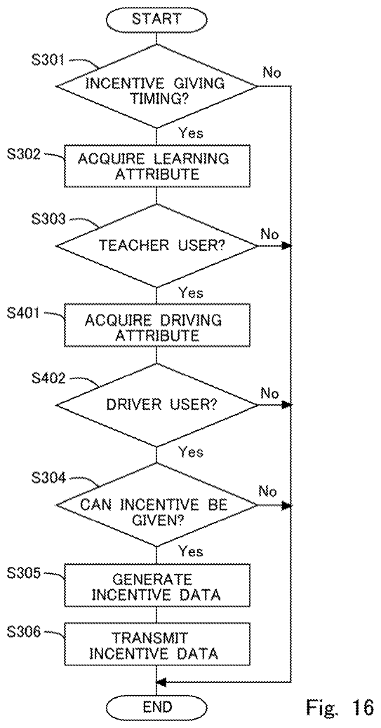

FIG. 16 is a flow chart illustrating a flow of incentive giving processing. A step in which the same processing as in the flow chart illustrated in FIG. 14 is performed is denoted by the same reference numeral as the corresponding step and its description will be omitted. This flow chart is executed in the incentive giving unit 307 of the server 30 for each user at predetermined time intervals. In the incentive giving processing illustrated in FIG. 16, if a positive determination is made in step S303, the process proceeds to step S401. In step S401, a driving attribute is acquired. The incentive giving unit 307 acquires the driving attribute of the user from the status information DB 313. In subsequent step S402, whether or not the user is a driver user is determined. When a positive determination is made in step S402, the process proceeds to step S304, and when a negative determination is made, the flow chart is terminated. Note that the sequence of processing in the carpool support system 1 is the same as the sequence illustrated in FIG. 15. Since an incentive is given to only teacher users who are driver users in this manner, securement of teacher users and vehicles 10 can be encouraged, thereby encouraging carpooling.

Note that the incentive given to a teacher user who is a driver user may be the incentive described in the first embodiment or preferential treatment available at a place to park the vehicle 10 related to the destination of the teacher user. For example, when the teacher user parks the vehicle 10 in a parking lot provided to the destination facility, he/she is allowed to preferentially park it near the gate of the facility. In this case, in order that the teacher user who is a driver user may park anytime, a predetermined place in the parking lot is left for the teacher user who is driver user and the server 30 guides the vehicle 10 so that it can be parked in the predetermined place. For example, the server 30 may transmit, as incentive data, a map indicating a predetermined place in the parking lot or a number indicating the predetermined place to the user terminal 20 of the teacher user.

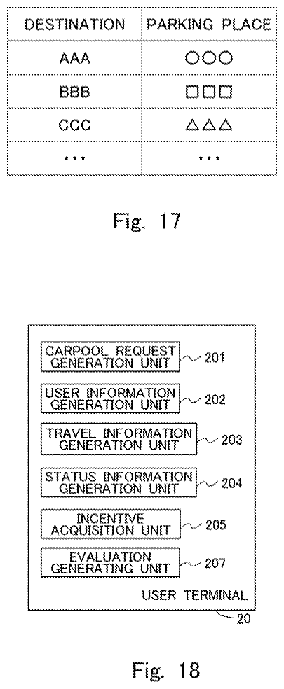

FIG. 17 is a diagram illustrating an example of the table configuration of incentive information stored in the incentive information DB 315. The incentive information table includes a destination field and a parking place field. In the destination field, information on destinations is input. In the parking place field, information on predetermined places in a parking lot related to a destination is input. The incentive giving unit 307 selects information on a predetermined place related to the destination of the teacher user, according to incentive information stored in the incentive information DB 315 and the destination of the teacher user stored in the travel information DB 312. The incentive giving unit 307 then generates incentive data representing the predetermined place and transmits it to the user terminal 20. In this case, to generate incentive data in step S305 in FIG. 16, the incentive giving unit 307 generates incentive data representing a map indicating the predetermined place in the parking lot or a number indicating the predetermined place according to incentive information illustrated in FIG. 17 and in step S306, transmits this incentive data to the user terminal 20 of the teacher user. Upon reception of the incentive data, the user terminal 20 displays the map indicating the predetermined place in the parking lot or the number indicating the predetermined place on the output unit 25. Note that the server 30 may transmit the map indicating the predetermined place in the parking lot to the apparatus 100 instead of the user terminal 20, and the output unit 15 of the apparatus 100 may output this map.

Further, for example, the server 30 may generate a travel path so that the final destination of the travel path generated by the server 30 becomes the predetermined place in the parking lot. For example, the incentive giving unit 307 may force the route generating unit 306 to generate a travel path so that the final destination becomes the predetermined place in the parking lot. In this case, the travel path generating processing illustrated in FIG. 13 is executed again, and the final destination is set to the predetermined place in the parking lot in step S202. Subsequently, the route generating unit 306 transmits the travel path to the user terminal 20 of the teacher user.

Note that the incentive given to a teacher user who is a driver user may be preferential treatment for waiting for parking the vehicle 10 at the destination of the teacher user. For example, when the teacher user parks the vehicle 10 in a parking lot provided to the destination facility, even if the parking lot is crowded and other users are waiting, the teacher user who is the driver user may be preferentially allowed to park so that his/her waiting time can be shortened. For example, the incentive giving unit 307 generates incentive data indicating that he/she can preferentially park, and transmits the generated incentive data to the user terminal 20 of the teacher user. This incentive data may be the same data independently of the parking lot. Upon reception of the incentive data, the user terminal 20 displays an image indicating that he/she can preferentially park, on the output unit 25. He/she can be preferentially allowed to park by presenting this image to a staff member of the parking lot or having it read by a reader apparatus at the parking gate.

### Third Embodiment

In the third embodiment, a student user evaluates a teacher user, and an incentive according to this evaluation is given to the teacher user. FIG. 18 is a diagram illustrating functional elements of a user terminal 20 in a case where a student user evaluates a teacher user. The user terminal 20 is the same as that described in the first embodiment except that it further includes an evaluation generating unit 207 as a functional element of the user terminal 20. The student user evaluates the teacher user and inputs the evaluation results to the user terminal 20 by operating the input unit 24. The evaluation generating unit 207 generates information (hereinafter referred to as evaluation information) on the evaluation of the teacher user. The evaluation generating unit 207 transmits the generated evaluation information to the server 30.

Upon acquisition of evaluation information, the incentive giving unit 307 of the server 30 generates incentive data to transmit to the user terminal 20 of the teacher user, based on the acquired evaluation information. Note that examples of evaluation adopted when multiple student users exist include the average score of all the student users, an evaluation by any student user (for example, a student user with a high reliability or a student user with a high usage frequency), an evaluation by the student user who gave the lowest evaluation, and an evaluation by the student user who gave the highest evaluation. When each student user individually gives an incentive to a teacher user, an incentive dependent on an evaluation by each student user is given. The server 30 then transmits the generated incentive data to the user terminal 20 of the teacher user. For example, in a case where a discount ticket available at a facility is transmitted to the teacher user as an incentive, the higher the evaluation by the student user is, the higher the discount rate adopted is. Alternatively, for example, in a case where a gift certificate is transmitted to the teacher user as an incentive, the higher the evaluation by the student user is, the higher the price of the gift certificate adopted is. Alternatively, for example, in a case where a predetermined type of points are transmitted to the teacher user as an incentive, the higher the evaluation by the student user is, the larger the number of points given is. A relationship between an evaluation given by the student user and an incentive given to the teacher user is predetermined and stored in the auxiliary memory 33. In a case where the class given by the teacher user does not satisfy the student user, no incentive may be given to the teacher user.

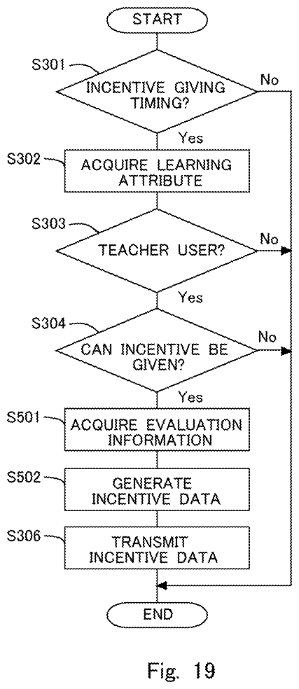

FIG. 19 is a flow chart illustrating a flow of incentive giving processing. A step in which the same processing as in the flow chart illustrated in FIG. 14 is performed is denoted by the same reference numeral as the corresponding step and its description will be omitted. This flow chart is executed in the incentive giving unit 307 of the server 30 for each user at predetermined time intervals. In the incentive giving processing illustrated in FIG. 19, if a positive determination is made in step S304, the process proceeds to step S501. In step S501, an evaluation information is acquired. Note that evaluation information acquired from the student is stored in the auxiliary memory 33, and the incentive giving unit 307 acquires the evaluation information from the auxiliary memory 33. In step S502, incentive data to be transmitted to the user terminal 20 of the teacher user is generated based on the evaluation information.

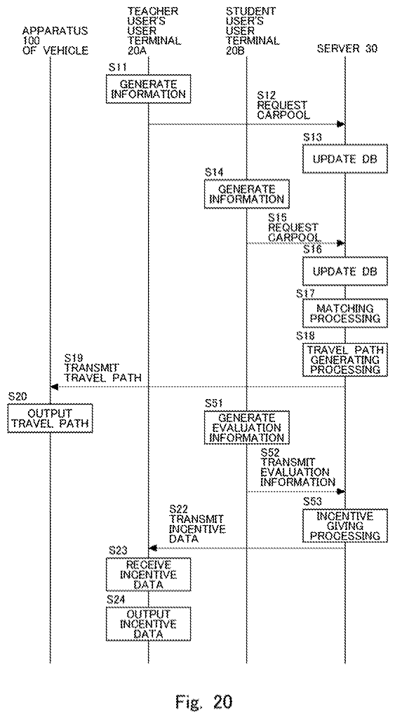

The operation of the carpool support system 1 will now be explained. FIG. 20 is a diagram illustrating a sequence of processing in the carpool support system 1. The same processing as in the sequence illustrated in FIG. 15 is denoted by the same reference numeral as the corresponding processing and its description will be omitted. Upon completion of learning in the vehicle 10, the student user operates the input unit 24 of the user terminal 20B to input an evaluation of the teacher user to the user terminal 20B. The user terminal 20B of the student user generates evaluation information according to this input (processing in S51). This evaluation information is transmitted to the server 30 (processing in S52). Subsequently, the incentive giving processing illustrated in FIG. 19 is executed based on this evaluation information (processing in S53).

Since the incentive given to the teacher user changes according to the results of evaluation of the teacher user given by the student user as described above, the teacher user works toward improving the quality of the content of the class to get a greater incentive. Hence, the learning efficiency for the student user is increased, thereby encouraging usage of carpooling.

### Fourth Embodiment

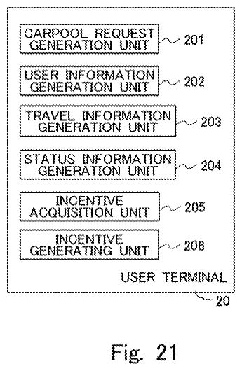

In the fourth embodiment, the server 30 acquires an incentive from the student user, and the server 30 gives this incentive to the teacher user. In other words, the student user gives an incentive to the teacher user indirectly via the server 30. FIG. 21 is a diagram illustrating functional elements of the user terminal 20 in a case where the student user gives an incentive to the teacher user indirectly via the server 30. The user terminal 20 is the same as that described in the first embodiment except that it further includes an incentive generating unit 206 as a functional element of the user terminal 20. The incentive generating unit 206 generates incentive data after the student user operates the input unit 24 of the user terminal 20 to give an incentive. This incentive data is transmitted from the user terminal 20 of the student user to the server 30.

Upon acquisition of incentive data from the user terminal 20 of the student user, the incentive giving unit 307 of the server 30 generates incentive data to transmit to the user terminal 20 of the teacher user, based on the acquired incentive data. A relationship between the incentive data transmitted from the user terminal 20 of the student user and the incentive data transmitted to the user terminal 20 of the teacher user is pre-stored in the incentive information DB 315. The server 30 then transmits incentive data to the user terminal 20 of the teacher user. Note that the incentive giving unit 307 may transmit incentive data received from the user terminal 20 of the student user to the user terminal 20 of the teacher user as it is. As described above, an incentive can be given from the student user to the teacher user indirectly via the server 30.

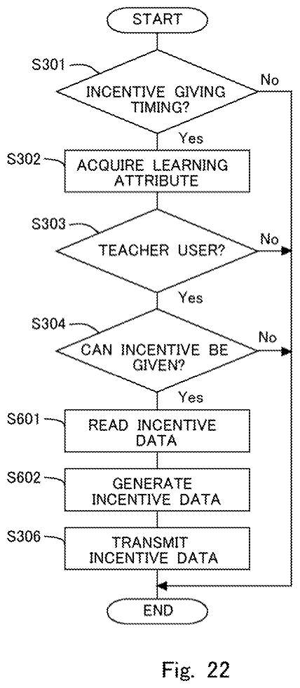

FIG. 22 is a flow chart illustrating a flow of incentive giving processing. A step in which the same processing as in the flow chart illustrated in FIG. 14 is performed is denoted by the same reference numeral as the corresponding step and its description will be omitted. This flow chart is executed in the incentive giving unit 307 of the server 30 for each user at predetermined time intervals. In the incentive giving processing illustrated in FIG. 22, if a positive determination is made in step S304, the process proceeds to step S601. In step S601, the incentive giving unit 307 acquires the incentive data that has been acquired from the student user and stored in the auxiliary memory 33. In subsequent step S602, incentive data to be transmitted to the user terminal 20 of the teacher user is generated based on the incentive data acquired from the student user.

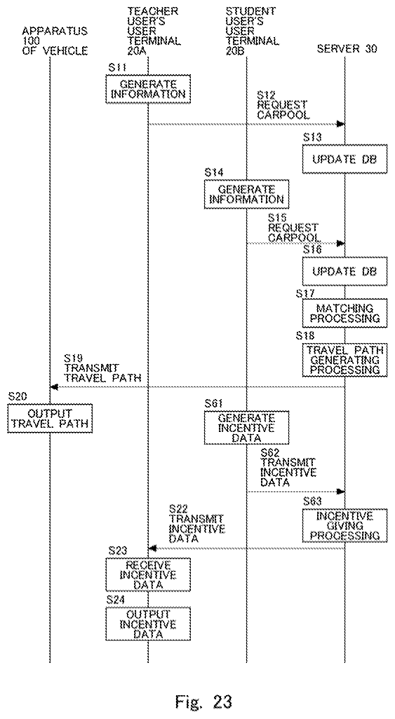

The operation of the carpool support system 1 will now be explained. FIG. 23 is a diagram illustrating a sequence of processing in the carpool support system 1. The same processing as in the sequence illustrated in FIG. 15 is denoted by the same reference numeral as the corresponding processing and its description will be omitted. Upon completion of learning in the vehicle 10, the student user operates the input unit 24 of the user terminal 20B to input the notification of the completion of the learning to the user terminal 20. The user terminal 20B of the student user generates incentive data according to this input (processing in S61). This incentive data is transmitted to the server 30 (processing in S62). Subsequently, the incentive giving processing illustrated in FIG. 22 is executed based on this incentive data (processing in S63).

Alternatively, an incentive may be directly given from the user terminal 20 of the student user to the user terminal 20 of the teacher user. For example, the user terminal 20 of the student user and the user terminal 20 of the teacher user can communicate with each other via a network N1. The incentive generating unit 206 then generates incentive data after the student user operates the input unit 24 of the user terminal 20 to give an incentive. For example, the incentive generating unit 206 may generate incentive data when the student user inputs the user ID of the teacher user to the user terminal 20 of the student user. The user terminal 20 of the teacher user to be given the incentive is identified based on the input user ID of the teacher user. The incentive generating unit 206 then transmits the incentive data from the user terminal 20 of the student user to the user terminal 20 of the teacher user. As described above, an incentive can be directly given from the student user to the teacher user.

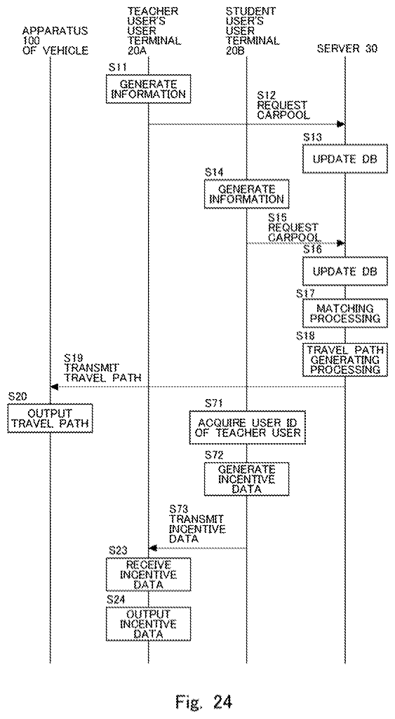

The operation of the carpool support system 1 in a case where an incentive is directly given from a student user to a teacher user will now be explained. FIG. 24 is a diagram illustrating a sequence of processing in the carpool support system 1. The same processing as in the sequence illustrated in FIG. 15 is denoted by the same reference numeral as the corresponding processing and its description will be omitted. In the processing in S71, the user terminal 20B of the student user acquires the user ID of the teacher user. The user ID of the teacher user is input by the student user to the user terminal 20B. In the processing in S72, the user terminal 20B of the student user generates incentive data, and this incentive data is transmitted to the user terminal 20A of the teacher user in the processing in S73.

### OTHER EMBODIMENTS

The above-described embodiment is merely illustrative and appropriate modification can be made without departing from the scope of the present disclosure. Note that an incentive may be given by transfer of money equivalent to the tuition fee into the teacher user's bank account. Transfer into the teacher user's bank account is made, for example, from the bank account of the company managing the server 30. In this case, the server 30 transfers the tuition fee from the company's bank account to the teacher user's bank account. Once the server 30 transfers the tuition fee to the teacher user's bank account, the server 30 transmits the notification of the completion of the transfer to the user terminal 20 of the teacher user. The student user operates the user terminal 20 to transfer the tuition fee from the student user's bank account to the company's bank account. The server 30 monitors the company's bank account and recognizes a relationship between the student user and the transfer amount.

The processing and units described in this disclosure can be freely combined unless technical inconsistencies arise.

In addition, processing supposed to be done with one device according to the above description may be executed with multiple devices. Alternatively, processing supposed to be done with different devices according to the above description may be executed with one device. In a computer system, the type of hardware configuration (server configuration) used to implement each function can be flexibly changed.

The present disclosure can be implemented when a computer program having the functions that have been described in the above embodiment implemented is supplied to a computer, and one or more processors in the computer read and execute the program. Such a computer program may be provided to the computer via a non-transitory computer-readable memory medium that can be connected to the computer's system bus or via a network. Examples of non-transitory computer-readable memory medium include any type of disks such as a magnetic disk (such as a floppy (registered trademark) disk and hard disk drive (HDD)), and an optical disk (such as CD-ROM, a DVD disk, and a Blu-ray disk), a read only memory (ROM), a random access memory (RAM), EPROM, EEPROM, a magnetic card, a flash memory, an optical card, and any type of media suitable for storing electronic instructions.

What is claimed is:

1. An information processing apparatus comprising a controller configured to:
when learning is provided in a carpool vehicle between a teacher user who is a user giving teaching and a student user who is a user receiving the teaching, acquire information for distinguishing between the teacher user and the student user, and
give an incentive to the teacher user.

2. The information processing apparatus according to claim 1, wherein
the controller acquires information for distinguishing between a driver of the vehicle and a non-driver of the vehicle, and
the controller gives the incentive to the teacher user only when the teacher user is the driver of the vehicle.

3. The information processing apparatus according to claim 1, wherein the controller acquires the incentive to be given to the teacher user, from the student user.

4. The information processing apparatus according to claim 1, wherein the controller gives the incentive associated with a destination of the teacher user to the teacher user.

5. The information processing apparatus according to claim 1, wherein
the controller acquires information on an evaluation of the teacher user from the student user, and
the controller gives an incentive dependent on the evaluation to the teacher user.

6. An information processing method comprising:
when learning is provided in a carpool vehicle between a teacher user who is a user giving teaching and a student user who is a user receiving the teaching, acquiring information for distinguishing between the teacher user and the student user; and
giving an incentive to the teacher user.

7. A program that causes a computer to:
when learning is provided in a carpool vehicle between a teacher user who is a user giving teaching and a student user who is a user receiving the teaching, acquire information for distinguishing between the teacher user and the student user, and
give an incentive to the teacher user.
